(19) United States
(12) Patent Application Publication
(10) Pub. No.: US 2020/0009715 A1
(43) Pub. Date: Jan. 9, 2020

(54) Interchangeable Tool Part Retention Device

(71) Applicant: Ty-Flot, Inc., Manchester, NH (US)

(72) Inventors: Darrell A. Moreau, Manchester, NH (US); Andre W. Moreau, Bedford, NH (US)

(73) Assignee: Ty-Flot, Inc., Manchester, NH (US)

(21) Appl. No.: 16/028,472

(22) Filed: Jul. 6, 2018

(51) Int. Cl. B25G 3/26; B23D 71/04

(52) U.S. Cl. CPC B25G 3/26; B25F 1/02; B23D 71/04

(57) ABSTRACT

A tool part retaining device includes a handle, a nut, and a fastener. The handle has a first end, a second end, and a handle body connecting the ends. The nut is in a first receptacle in the first end of the handle. The nut has a first channel, a second channel which connects to the first channel at a junction, at least one nut side, and at least one recess in the at least one nut side. The fastener is disposed in a second receptacle in the handle body near the first end of the handle and is also disposed in the second channel in the nut.

### BACKGROUND OF THE INVENTION

### 1. Field of the Invention

The present invention relates generally to hand tools. Particularly, the present invention relates to retention mechanisms between a tool handle and an interchangeable tool part.

### 2. Description of the Prior Art

Hand tools are widely used in construction, maintenance, and industrial facilities operations. Interchangeable tool parts can be used to allow one tool base to be used with multiple parts. Using a variety of parts permits the use of a single tool handle for a plethora of applications. For example, a #2 Phillips head may be necessary for one screw whereas another screw may require a ¼″ flathead. A screwdriver with interchangeable heads allows exchanging one screwdriver bit for another screwdriver bit as the job so requires. Other tools may also utilize interchangeability. For example, a file handle may have multiple file types for various applications dependent on the material to be filed and goal.

Some tasks require work to be performed at elevated heights; for such tasks, dropping a tool can result in injury to individuals, equipment, objects, and the tool itself. Tools may be secured to stationary objects such as structures, people, or articles of clothing to prevent the unintentional falling of a tool.

Tool part interchangeability is particularly useful when working at heights or in other situations in which storage space is at a premium. However, replaceable tool parts are not typically tethered to stationary objects and may detach from a tool, resulting in the same or similar injuries as a dropped tool. As a result, it is necessary to secure tool parts together in a manner which also permits interchangeability of the tool parts. Previous methods for securing tool parts together include use of pressure retention, male-to-female connectors, and magnetic clamps.

One approach of retaining an interchangeable tool part on a handle is by pressure retention. Pressure retention such as clamping occurs when a material provides tension on multiple sides of an object such that the tension anchors the object to the material. For example, a nail driven into a wall is retained by pressure applied by the wall to the sides of the nail. Similarly, a hand file may be mounted to a wooden handle by driving the tang into a receiving end of the wooden handle.

Another approach of retaining an interchangeable tool part is disclosed in US Published Application No. 2015/0217440 to Levesque. The Levesque publication discloses a modular tool construction comprising a tool shaft with a first and second connector assembly that are adapted to removably support tool implements at each end, whereby the tool can take on different tasks without resorting to multiple, single-use tools. The connector assemblies comprise an elongated, male connector member that is adapted to be received by a complimentary female member. The connection between the male and female members aligns the tool shaft with the tool implement. A slidable sleeve is thereafter positioned over the joint and threadably secured thereover. The internal members and the sleeve provide sufficient support to prevent prying and failure at the joint location, while also providing for ease of attachment and removal of different implements. The tool shaft is adapted to comprise a male and a female connector member at opposing ends.

Another approach of retaining an interchangeable tool part is disclosed in US Published Patent Application No. 2002/0101311 to May. The May publication discloses a magnet clamp for use with a hand tool. It provides a magnet that can be reversibly attached to an existing commercially-available hand-held tool without modification of the tool, thereby providing a way to securely hold various small metal items associated with the hand tool, while making the items readily available for use. Drill bits, saw blades, nails, screws, bolts, tacks, chuck keys, or any small objects made of or alloyed with a ferromagnetic substance such as iron or steel may be securely held by the present invention.

### SUMMARY OF THE INVENTION

Although previous methods have lessened the number of injuries and damaged tools caused when interchangeable tool parts inadvertently fall, additional measures can be taken to improve safety. Safety can be further enhanced by enhancing the retention of interchangeable tool parts. Previous methods can be improved upon by further providing an interchangeable tool part retention device which may releasably and non-destructively affix an interchangeable tool part to a corresponding handle.

It is an object of the present invention to provide an interchangeable tool part retention device.

It is another object of the invention to increase retention of interchangeable tool parts by the handle they are attached to.

It is still another object of the invention to increase safety on worksites by reducing tool part droppage.

The present invention achieves these and other objectives by providing a tool part retaining device. In one embodiment of the present invention, the tool part retaining device has a handle with a first end, a second end opposite the first end, and a handle body connecting the first end to the second end. The tool part retaining device further has a first receptacle in the first end and a second receptacle in the handle body near the first end transverse to the first receptacle and intersecting with the first receptacle to form a receptacle junction. The tool part retaining device further has a nut in the first receptacle. The nut has a nut body with a nut first end, a nut second end, at least one nut side, and at least one recess in the side or in at least a portion of the side. The nut also has a first channel in the nut body on the nut first end and a second channel in the nut body on at least one nut side. The second channel is transverse or perpendicular to the first channel, and the first channel meets the second channel to form a channel junction. A fastener is disposed in the second receptacle of the handle and the second channel of the nut. The fastener engages with the nut.

In another embodiment of the invention, the nut of the tool part retaining device has six corners and six recesses. The recesses are embedded in each of the six corners and spaced from the nut second end.

In another embodiment of the invention, the nut has a third channel opposite and concentric with the first channel. The first channel communicates with the third channel at the junction.

In yet another embodiment of the invention, the first channel has a first channel thread, the second channel has a second channel thread, and the third channel has a third channel thread.

In still another embodiment of the invention, the first channel thread is #10-32 UNF, the second channel thread is #10-40 UNC, and the third channel thread is ¼-28 UNF.

In another embodiment of the invention, the second channel extends completely through the nut.

In another embodiment of the invention, an interchangeable tool part is disposed in the first channel. The fastener engages with the interchangeable tool part.

In yet another embodiment of the invention, the interchangeable tool part is a hand file and the fastener applies contact pressure to a side of the hand file.

In another embodiment of the invention, the fastener anchors a tool part into the first receptacle via pressure retention.

In another embodiment of the present invention, the nut is made of high carbon steel.

In yet another embodiment of the present invention, the nut has a hardness of HRC 40-45.

In one embodiment of the invention, an interchangeable tool part is retained by inserting a tool part into a first thread of a nut. The nut is in a first receptacle in a first end of a tool handle. The retention method further includes screwing the tool part into the first thread and inserting a fastener into a second receptacle in a side of the tool handle. The retention method also includes engaging the first fastener with a second thread of the nut and engaging the first fastener with the tool part at a first engagement site.

In another embodiment of the invention, engaging the fastener with the first thread of the nut is screwing the fastener into the first threading of the nut. Moreover, engaging the first fastener with the second threading of the nut is screwing the first fastener into the second threading of the nut. Additionally, engaging the first fastener with the tool part is applying surface contact pressure from the first fastener to the tool part.

In another embodiment of the invention, the first thread is #10-32 UNF and the second thread is #10-40 UNC.

In another embodiment of the invention, an interchangeable tool part is retained by further inserting a second fastener into a third receptacle in the handle opposite the second receptacle, engaging the second fastener with the nut, and engaging the second fastener with the tool part at a second engagement site opposite the first engagement site.

In one embodiment of the invention, a hand file secured in a handle has a handle portion with a first end, a second end opposite the first end, and a handle body connecting the first end to the second end. There is a forward receptacle in the first end. There is also a side receptacle in the handle body near the first end connecting with the forward receptacle to form a receptacle junction. A nut is in the forward receptacle. The nut has a nut body with a first surface, a second surface, and at least one side connecting the second surface to the first surface. The nut also has a front channel extending from the first surface to the second surface. The front channel is approximately concentric with the forward receptacle. The nut also has a side channel through one or more of the at least one side. The side channel is approximately concentric with the side receptacle. There is a first recess in one or more of the at least one side. The hand file secured in the handle further has a hand file with a tang disposed in the forward receptacle, and the tang is engaged by the nut. A fastener in the side receptacle engages the nut and the tang.

In another embodiment of the invention, the side channel has a second channel thread and the second channel thread is #10-40 UNC. Further, the front channel has a front channel thread and the front channel thread is ¼-28 UNF.

In yet another embodiment of the invention, the tang engages the nut by screwing into the front channel. Further, the fastener engages the nut via screwing into the side channel. Additionally, the fastener engages the tang by applying contact pressure to the tang.

In another embodiment of the invention, the nut is made of heat-treated high carbon steel.

In another embodiment of the invention, the nut has a hexagonal shape with a first corner, a second corner, a third corner, a fourth corner, a fifth corner, and a sixth corner. The first recess is disposed on the first corner. The nut further has a second recess disposed on the second corner, a third recess disposed on the third corner, a fourth recess disposed on the fourth corner, a fifth recess disposed on the fifth corner, and a sixth recess disposed on the sixth corner.

In another embodiment, there is disclose a hand file secured in a handle. The hand file secured in a handle includes (1) a handle comprising a first end, a second end opposite the first end, and a handle body connecting the first end to the second end, (2) a first receptacle in the first end, (3) a second receptacle in the handle body proximate the first end, the second receptacle being transverse to the first receptacle and intersecting with the first receptacle to form a receptacle junction, (4) a nut disposed in the first receptacle, the nut comprising a nut body with a first end, a second end, and at least one side connecting the second end to the first end, a first channel extending completely through the nut from the first end to the second end, the first channel being concentric with the first receptacle, a second channel extending through the at least one side to intersect with the first channel, the second channel being concentric with the second receptacle, and a first recess in the at least one side, a hand file with a tang disposed in the first receptacle, the tang engaged by the nut, and a fastener disposed in the body receptacle, the fastener engaging the nut and the tang.

In another embodiment of the hand file secured to a handle, the second channel has a second channel thread and the second channel thread is #10-40 UNC, and the first channel has a first channel thread and the first channel thread is ¼-28 UNF.

In another embodiment of the hand file secured to a handle, the thread of the first channel bites into the tang when the tang is screwingly inserted into the first channel.

In one embodiment of the hand file secured to a handle, the nut is made of heat-treated high carbon steel.

In one embodiment of the hand file secured to a handle, the nut body has six sides with each adjacent side forming six corners and wherein each of the six corners has a recess.

### BRIEF DESCRIPTION OF THE DRAWINGS

FIG. 1 is a front perspective view of the tool handle with a fastener shown exploded from the tool handle.

FIG. 2 is a left side exploded view of the tool handle shown in FIG. 1 showing a nut exploded from the front of the tool handle.

FIG. 3 is a side view of the nut shown in FIG. 3.

FIG. 4 is a side cross-sectional view of the nut shown in FIG. 3.

FIG. 5 is a top view of the nut shown in FIG. 3.

FIG. 6 is a top cross-sectional view of the nut shown in FIG. 5.

FIG. 7 is a left side view of the D-ring collar shown in FIG. 1.

FIG. 8 is a front view of the D-ring collar shown in FIG. 7.

FIG. 9 is a left side cross-sectional view of the D-ring collar shown in FIG. 7.

FIG. 10 is a right side view of the D-ring collar shown in FIG. 7.

FIG. 11 is a rear view of the D-ring collar shown in FIG. 7.

FIG. 12 is a right side cross-sectional view of the D-ring collar shown in FIG. 7.

FIG. 13 is a left side view of the collar retainer shown in FIG. 1.

FIG. 14 is a front view of the collar retainer shown in FIG. 13.

FIG. 15 is a right side view of the collar retainer shown in FIG. 13.

FIG. 16 is a rear view of the collar retainer shown in FIG. 13.

FIG. 17 is a perspective view of one embodiment of the present invention showing a tool handle with a hand file removeably attached via an interchangeable tool part retention device.

### DETAILED DESCRIPTION OF THE PRESENT INVENTION

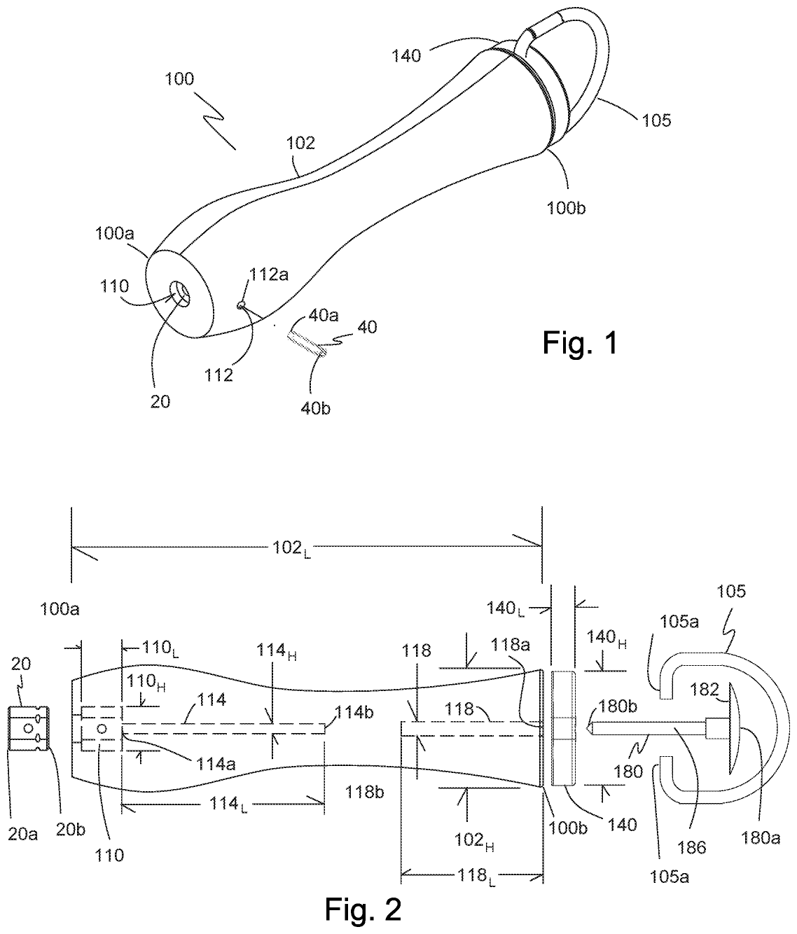

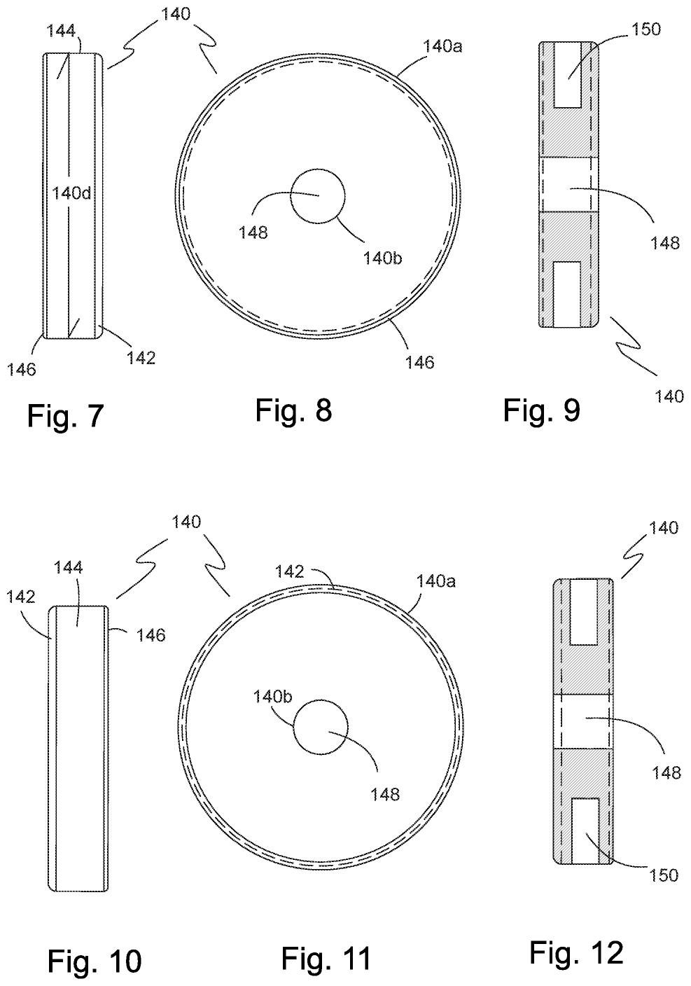

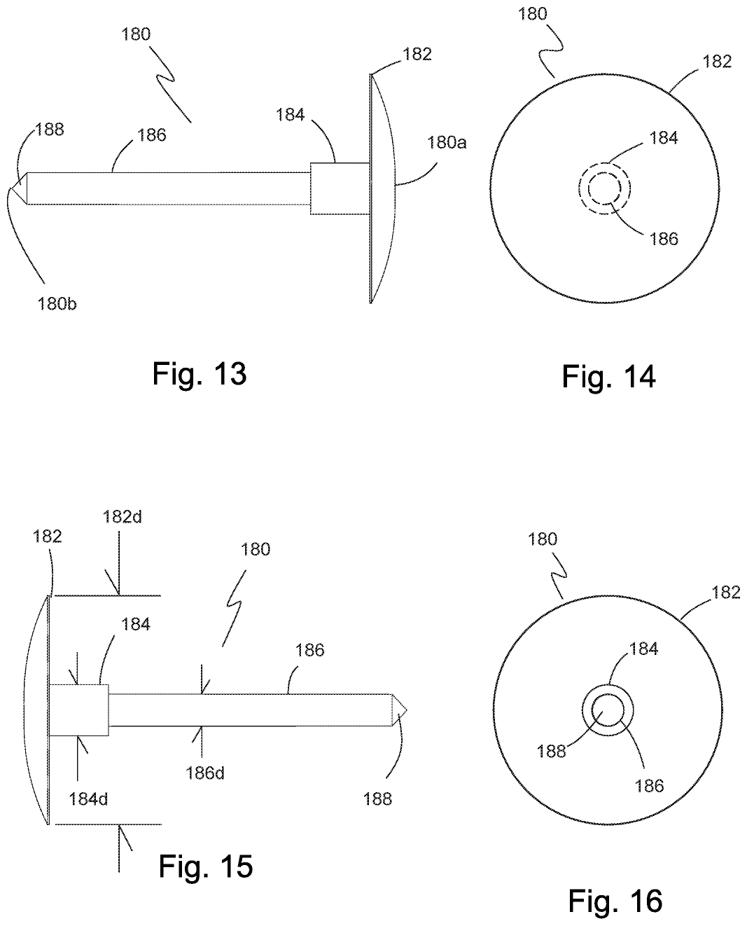

The preferred embodiments of the present invention are illustrated in FIGS. 1-17. FIG. 1 is a perspective view showing one embodiment of the present invention which includes a tool handle 100 with a fastener 40 exploded from tool handle 100. Tool handle 100 includes a handle body 102, a first end 100a, a second end 100b opposite first end 100a, a first receptacle 110 disposed within first end 100a, a second receptacle 112 transverse or perpendicular to first receptacle 110 and spaced from first end 100a, and an interchangeable tool part retention device 20 (partially shown).

In this embodiment, tool handle 100 has a D-ring collar 140 attached to second end 100b of tool handle 100 with a D-ring 105 attached to D-ring collar 140. Preferably, D-ring collar 140 is rotatably attached to tool handle 100 and D-ring 105 is pivotally attached to D-ring collar 140. A forward aperture 110a in tool handle 100 grants access to interchangeable tool part retention device 20. Fastener 40 which is typically disposed in second receptacle 112 is shown here exploded from second receptacle 112.

Fastener 40 has a drive end 40a and an insert end 40b. Drive end 40a may be a screw head and insert end 40b may be a screw tip.

In this embodiment, fastener 40 is a pin 40 with a hexagonal drive 40c. Other embodiments may use a screw, nail, or other fastener known in the art. Preferably, fastener 40 is a screw. More preferably, fastener 40 is a set screw. In this embodiment, insert end 40b of fastener 40 has a #10-40 UNC thread. Other embodiments may vary the size of the fastener 40 and/or the type of drive 40c.

Insert end 40b is the end of fastener 40 to first enter second receptacle 112. Fastener 40 enters second receptacle 112 at handle side aperture 112a to engage with nut 20 and interchangeable tool part 116 (not shown). Fastener 40 engages with both nut 20 and interchangeable tool part 116 (not shown). Fastener 40 enters second receptacle 112 at side aperture 112a to enter a side channel 12 of nut 20 (not shown). Preferably, fastener 40 applies retention pressure to the tang of a hand file 116 (not shown).

Fastener 40 enters second receptacle 112 at side aperture 112a and attaches to nut 20. When fastener 40 is in second receptacle 112 and fastener 40 and nut 20 are each attached to the other, insert end 40b is in second receptacle 112 and drive end 40a may be inside of second receptacle 112, outside of second receptacle 112, or flush with side aperture 112a. Preferably, upon attachment, drive end 40a is either flush with side aperture 112a or, more preferably, inside of second receptacle 112.

Nut 20 is disposed in first receptacle 110. In the present embodiment, nut 20 is permanently embedded in tool handle 102 as tool handle 102 is molded around nut 20. Other embodiments may connect nut 20 to tool handle 102 by other means such as using one or more adhesives, pressure retention, or other attachment mechanisms. Still other embodiments may use fastener 40 to anchor nut 20 into tool handle 102.

Turning now to FIG. 2, there is illustrated an exploded view of tool handle 100. When nut 20 is in first receptacle 110 and nut 20 and fastener 40 are each attached to the other, nut rear end 20b is in first receptacle 110 and nut front end 20a may be inside of first receptacle 110, outside of first receptacle 110, or flush with forward aperture 110a. Preferably, upon attachment, nut front end 20a is either flush with forward aperture 110a or, more preferably, inside of first receptacle 110. First receptacle 110 has a first receptacle height 110_{H} and a first receptacle length 110_{L}. First receptacle height 110_{H} is at least great enough to permit disposition of nut 20 into first receptacle 110.

First receptacle length 110_{L} is at least great enough to permit disposition of a portion of nut 20 into first receptacle 110. Preferably, first receptacle length 110_{L} will be equal to or longer than the length of nut 20 such that nut 20 either rests flush with forward aperture 110a or is fully inside first receptacle 110. More preferably, first receptacle length 110_{L} will be slightly longer than nut 20 to permit nut 20 to rest fully within first receptacle 110 with some additional space between nut 20 and forward aperture 110a.

Tool handle 100 has a handle front end 100a, a handle rear end 100b, a tool handle height 100_{H} and a tool handle length 102. Tool handle height 100_{H} and tool handle length 100_{L} are at least large enough to accommodate a grip for a hand. Tool handle 100 also includes a tool receptacle 114 to receive an insertable portion of an interchangeable tool part 116 (not shown) such as the tang of a hand file. Tool handle 100 has a tool receptacle aperture 114a for entry into tool receptacle 114 from first receptacle 110. Tool receptacle 114 has a tool receptacle end 114b opposite tool receptacle aperture 114a. Tool receptacle 114 has a tool receptacle height 114_{H} and a tool receptacle length 114. Tool receptacle height 114_{H} and tool receptacle length 114_{L} are smaller than tool handle height 100_{H} and tool handle length 100, respectively, but large enough to receive an insertable portion of interchangeable tool part 116 (not shown) such as, for example, the tang of a hand file.

Tool handle 100 optionally includes a collar receptacle 118 when tool handle 100 includes a rotatable D-ring at handle rear end 100b. Collar receptacle 118 is adapted to receive an insertable portion of collar retainer 180. Collar receptacle 118 has a collar receptacle aperture 118a at handle rear end 100b for entry into collar receptacle 118 and a collar receptacle end 118b opposite collar receptacle aperture 118a. Collar receptacle 118 has a collar receptacle height 118_{H} and a collar receptacle length 118. Collar receptacle height 118_{H} and collar receptacle length 118_{L} are smaller than tool handle height 102_{H} and tool handle length 102, respectively. Collar receptacle 118 is large enough to receive collar rod 186 but small enough to prevent entry of collar cap 182. Thus, collar inward end 180b may enter collar receptacle 118 but opposing collar outward end 180a cannot enter collar receptacle 118.

D-ring collar 140 optionally rotatably attaches to tool handle 100 at second end 100b and retains D-ring 105. D-ring 105 has a pair of opposed D-ring ends 105a that are received into D-ring collar 140. D-ring collar 140 is disposed between tool handle 100 and collar retainer cap 180a. D-ring collar height 140_{H} may be greater than, equal to, or less than tool handle height 102_{H}. Preferably, D-ring collar height 140_{H} is comparable to tool handle height 102_{H} such that D-ring collar height 140_{H} is neither substantially greater than nor substantially less than tool handle height 102_{H}. More preferably, D-ring collar height 140_{H} is approximately equal to tool handle height 102_{H}. D-ring collar length 140_{L} is at least great enough to accommodate D-ring 105. Specifically, D-ring collar length 140_{L} is at least great enough to allow for entry of D-ring 105 into D-ring collar 140 with D-ring collar 140 flanking both sides of D-ring 105 to retain D-ring 105.

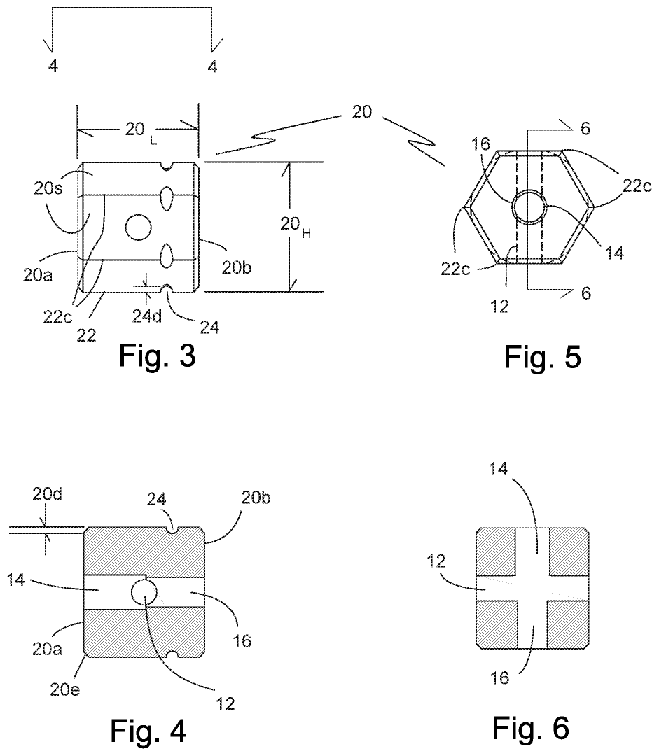

FIGS. 3 and 4 show a side view of nut 20 and a cross-sectional side view of nut 20, respectively. Line 4 indicates the directional view taken in FIG. 3 for the cross-sectional view of FIG. 4. Although nut 20 may be any kind of nut, it is preferred that at least a portion of nut body 22 is hexagonally shaped. More preferably, nut 20 is a hex, heavy hex, jam, nylon insert, or nylon insert jam nut. Even more preferably, nut 20 is a hex, heavy hex, or jam nut.

Nut 20 has a nut body 22, a nut front end 20a, a nut rear end 20b, and one or more connecting sides 20s connecting nut rear end 20b to nut front end 20a. Nut 20 has at least one recess 24 on at least one connecting side 20s of nut body 22. Recess 24 may be a spot recess, as shown, such that there is a definable central point of recess 24. Recess 24 may be a band recess such that there is a definable central line of recess 24. Nut 20 may have one recess 24, but a plurality of recesses 24 is preferred. A band recess may be a ring about nut body 22. If nut 20 is hexagonally shaped and has a single recess 24 as a ring about nut body 22, the depth of recess 24 may increase at corners 22c of the hexagonal shape. Preferably, recesses 24 are spot recesses only in corners 22c of the hexagonal shape. Preferably, recesses 24 are proximate nut rear end 20b. In this embodiment, nut 20 has six corners 22c. Each corner 22c has a recess 24. Nut 20 has beveled edges 20e. Each recess 24 has a depth 24d approximately equal to beveled edge depth 20d. In other embodiments, different recesses 24 may have different depths 24d, and depths 24d may be less than or greater than the depth 20d of a correlated beveled edge 20e.

Nut 20 has a nut height 20_{H} and a nut length 20_{L}. First receptacle 110 has a first receptacle height 110_{H} and a first receptacle length 110. First receptacle height 110_{H} is at least large enough to permit disposition of nut 20 into first receptacle 110. Thus, first receptacle height 110_{H} is equal to or greater than nut height 20_{H}. Preferably, first receptacle height 110_{H} will be slightly greater than nut height 20_{H} to allow a snug fit between nut 20 and first receptacle 110. More preferably, first receptacle height 110_{H} is slightly greater than nut height 20_{H} and a cap is molded over a portion of nut 20. Even more preferably, handle body 102 is molded around nut 20. Other embodiments may utilize a first receptacle height 110_{H} much greater than nut height 20_{H} and fill in excess space with a filler substance such as an adhesive, mold a cap over one or more parts of nut 20, attach nut 20 to handle body 102 via adhesive between contacting surfaces, and/or anchor nut 20 in handle body 102 with one or more fasteners 40 (not shown).

Nut 20 has a side channel 12, a front channel 14, and a rear channel 16. Front channel 14 extends from nut front end 20a a predefined depth into nut 20. Rear channel 16 extends from nut rear end 20b a predefined depth into nut 20 and communicates with front channel 14. Side channel 12 extends between opposing locations on connecting side 20s. For a nut 20 with only one connecting side 20s, connecting side 20s has opposing locations when one is halfway around the circumference of connecting side 20s from the other. Preferably, opposing locations are on connecting sides 20s opposite and parallel each other. Side channel 12 is transverse or perpendicular to front channel 14 and rear channel 16 and, preferably, perpendicular to channels 14 and 16. Front channel 14 and rear channel 16 connect at side channel 12. Each of the channels 12, 14, and 16 may be different sizes or the same size. It is contemplated that side channel 12 extends from connecting side 20s into nut 20 only a sufficient distance to extend across channels 14, 16 having the largest diameter. Channels 14 and 16 are threaded and channel 12 is optionally threaded. Front channel 14 is larger than rear channel 16 to accommodate the taper of the tang of a file. Typical thread sizes are #10-40 UNC for side channel 12, #10-32 UNF for front channel 14, and ¼-28 UNF for rear channel 16.

Nut 20 is made of rigid material with hardness great enough to prevent degradation throughout numerous attachments with and detachments from interchangeable tool parts 116 (not shown). Preferably, nut 20 is made of high carbon steel. Preferably, nut 20 is heat treated. More preferably, nut 20 is HRC 40-45 on the Rockwell scale.

FIGS. 5 and 6 show a front end view of nut 20 and a cross-sectional view of nut 20 taken along lines 6-6 in FIG. 5, respectively. Front channel 14 and rear channel 16 are concentric. Side channel 12 is transverse and, in this embodiment, perpendicular to front channel 14 and rear channel 16. Side channel 12 extends, in this embodiment, completely through nut 20 and forms a junction with front channel 14 and rear channel 16 proximate center of nut 20. In other embodiments, side channel 12 extends sufficiently into nut 20 so that channel 12 extends at least across the diameters of front channel 14 and rear channel 16. An insertable portion of interchangeable tool part 116 (not shown) may be inserted into front channel 14 and extend partially through, entirely through, or beyond the junction such that fastener 40 (shown in FIG. 1) inserted into side channel 12 may engage with interchangeable tool part 116 (not shown).

FIGS. 8, 9, and 10 show a right side view, a rear view, and a cross-sectional left side view, respectively, of D-ring collar 140. D-ring collar 140 has an outer circumference 140a and an inner circumference 140b. Outer circumference 140a has an outer circumference diameter 140d which is, in this embodiment, approximately the same as tool handle height 102_{H}. Inner circumference 140b defines collar tunnel 148 extending through D-ring collar 140.

D-ring collar 140 has an outer collar 142, a center collar 144, and an inner collar 146. Center collar 144 defines one or more D-ring receptacles 150. Preferably, D-ring collar 140 has two D-ring receptacles 150 which are in opposing locations on D-ring collar 140 to allow D-ring 105 (shown in FIGS. 1 and 2) to pivotally attach to D-ring collar 140.

FIGS. 11, 12, and 13 show a right side view, a front view, and a cross-sectional right side view of D-ring collar 140, respectively. D-ring collar 140 is generally disc shaped. In this embodiment, collar tunnel 148 is coincident with the center of the disk shape of D-ring collar 140. Collar tunnel 148 extends completely through the entire length of D-ring collar. D-ring receptacles 150 are approximately perpendicular to collar tunnel 148.

In this embodiment, D-ring receptacles 150 do not intersect. In the present embodiment, D-receptacles 150 have a depth sufficient to capture opposed ends of D-ring 105.

FIGS. 14 and 15 show a left side view and a rear view of collar retainer 180, respectively. Collar retainer 180 has a retainer cap end 180a and a retainer insert end 180b. Collar retainer 180 has a cap segment 182 at retainer cap end 180a, a shank segment 184 adjacent cap segment 182, and a shaft segment 186 between shank segment 184 and a tip segment 188 at retainer insert end 180b.

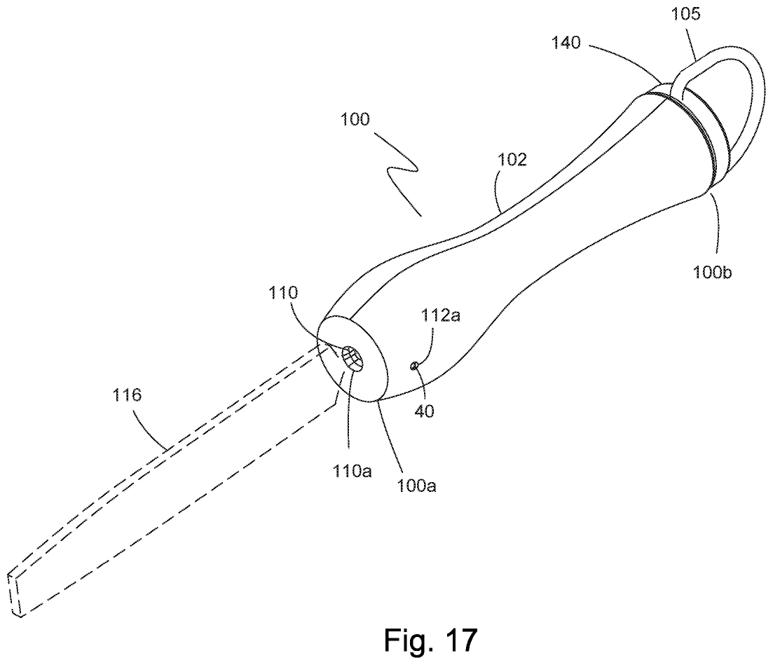

FIGS. 16 and 17 show a right side view and front view of collar retainer 180, respectively. Retainer cap 182 has a retainer cap diameter 182d, shank segment 184 has a shank diameter 184d, and shaft segment 186 has a shaft diameter 186d. Retainer cap diameter 182d is greater than shank diameter 184d and shaft diameter 186d. This permits collar insert end 180b to enter collar tunnel 148 (shown in FIGS. 8, 9, 11, and 12) and collar receptacle 118 (shown in FIG. 2) but prevents retainer cap end 180a from entering collar tunnel 148 or collar receptacle 118. Shank diameter 184d and shaft diameter 186d may be the same size or different sizes. Preferably, shaft diameter 186d is greater than shank diameter 184d, which provides for a stop surface (not numbered) to butt up against handle rear end 100b allowing collar 140 to rotate relative to handle 100 and collar retainer 180.

Turning now to FIG. 17, nut 20 receives and retains an interchangeable tool part 116. Preferably, interchangeable tool part 116 forcibly threads into nut 20 since the material of interchangeable tool part 116 is softer than nut 20 so that the threads in channels 14 and 16 of nut 20 groove into tool part 116 providing a friction retention of interchangeable tool part 116. In this embodiment, nut 20 is disposed to engage the tang of a hand file. In other embodiments, interchangeable tool part 116 may be a drill bit, wrench, socket, hammer head, or other part, which has an extension that fits into channel 14 of nut 20 and which may be used with a tool handle 100.

In this embodiment, the majority of the tang of the hand file is disposed in handle 100. Specifically, more than 80% of the length of the tang of the hand file is disposed in handle 100, extending beyond nut 20 and first receptacle 110 into tool receptacle 114 (shown in FIG. 2). Other embodiments may have more or less of the tang disposed in handle 100. Enough of the tang must be disposed in handle 100 for at least a portion of the tang length to extend beyond at least a portion of second receptacle 112 so that fastener 40 also locks with and prevents the interchangeable tool part 116 from unthreading out of channel 14. Preferably, the tang will extend at least to the entire diameter or greater than the entire diameter of second receptacle 112.

When disposed in second receptacle 112, fastener 40 (shown in FIG. 1) engages both nut 20 and interchangeable tool part 116. Fastener 40 may engage nut 20 and interchangeable tool part 116 via screw threads, surface contact, or other contact. Preferably, fastener 40 engages nut 20 via screw threading. Preferably, fastener 40 engages interchangeable tool part 116 via surface contact.

In one embodiment, nut 20 engages the tang of the hand file such that about half of the length of the tang is within tool handle 100. In another embodiment, fastener 40 engages the tang of the hand file approximately halfway between the tang's junction with handle front end 100a of tool handle 100 and the inserted end of the tang. In another embodiment, fastener 40 engages the tang nearer the handle front end 100a than the inserted end of the tang.

Other embodiments may employ a plurality of fasteners 40 disposed in additional receptacles in handle 100. For example, a third receptacle may be disposed in handle 102 opposite second receptacle 112 where another fastener 40 is disposed in the third receptacle such that pressure applied to an intervening unit such as a tang of a hand file is directly oppositional. Other embodiments may employ additional fasteners and additional receptacles in a similar way. For example, two pairs of directly oppositional fasteners 40 may be used. Further, three fasteners 40 may be spaced evenly about the circumference of handle 102, or there may be one pair of directly oppositional fasteners 40 and one fastener 40 perpendicular to the directly oppositional fasteners 40. Other spacings or number of fasteners 40 are also contemplated.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A tool part retaining device for a hand tool comprising:
a handle having a first end, a second end opposite the first end, and a handle body connecting the first end to the second end;
a first receptacle disposed in the first end;
a second receptacle disposed in the handle body proximate the first end, the second receptacle being transverse to the first receptacle and intersecting with the first receptacle to form a receptacle junction;
a nut disposed in the first receptacle, the nut comprising:
a nut body having a nut first end, a nut second end, at least one nut side, and at least one recess in the at least one nut side;
a first channel disposed in the nut body in the nut first end; and
a second channel disposed in the nut body on at least one nut side wherein the second channel is transverse to the first channel, and wherein the second channel of the nut is concentric with the second receptacle of the handle body and wherein the first channel meets the second channel to form a channel junction; and
a fastener disposed in the second receptacle of the handle and engages the second channel of the nut.

2. The retaining device of claim 1 wherein the nut has six sides forming six corners wherein the at least one recess is formed in each of the six corners.

3. The retaining device of claim 1 wherein the nut has a third channel opposite and concentric with the first channel, wherein the first channel communicates with the third channel at the channel junction.

4. The retaining device of claim 3 wherein the first channel has a first channel thread, the second channel has a second channel thread, and the third channel has a third channel thread.

5. The retaining device of claim 4 wherein:
the first channel thread is #10-32 UNF;
the second channel thread is #10-40 UNC; and
the third channel thread is ¼-28 UNF.

6. The retaining device of claim 1 wherein the second channel extends completely through the nut.

7. The retaining device of claim 1 further comprising an interchangeable tool part disposed in the first channel and wherein the fastener engages with the interchangeable tool part.

8. The retaining device of claim 6 wherein the interchangeable tool part is a hand file and the fastener applies contact pressure against a side of the hand file.

9. The retaining device of claim 1 wherein the fastener anchors a tool part into the first receptacle via pressure retention.

10. The retaining device of claim 1 wherein the nut is made of high carbon steel.

11. The retaining device of claim 10 wherein the nut has a hardness in the range of HRC 40-45.

12. A method of fastening a tool part in a tool handle, the method comprising:
inserting a tool part into a first channel of a nut wherein the first channel has an internal thread and wherein the nut is disposed in a first receptacle in a first end of a tool handle;
screwing the tool part into the first channel a sufficient distance to intersect with a second channel of the nut, the second channel being transverse to the first channel of the nut and the second channel having an internal thread;
inserting a fastener into a second receptacle in a side of the tool handle, the second receptacle intersecting with the first receptacle;
screwing the first fastener into a second channel of the nut wherein the second channel is concentric with the second receptacle of the handle; and
engaging the first fastener with the tool part in the first channel of the nut.

13. The method of fastening of claim 12 further comprising:
selecting a tool part having a Rockwell hardness lower than the Rockwell hardness of the nut.

14. The method of fastening of claim 12 further comprising:
inserting a second fastener into a third receptacle in the handle opposite the second receptacle;
engaging the second fastener with the nut; and
engaging the second fastener with the tool part at a second engagement site opposite the first engagement site.

15. A hand file secured in a handle comprising:
a handle comprising:
a first end;
a second end opposite the first end; and
a handle body connecting the first end to the second end;
a first receptacle in the first end;
a second receptacle in the handle body proximate the first end, the second receptacle being transverse to the first receptacle and intersecting with the first receptacle to form a receptacle junction;
a nut disposed in the first receptacle, the nut comprising:
a nut body with a first end, a second end, and at least one side connecting the second end to the first end;
a first channel extending completely through the nut from the first end to the second end, the first channel being concentric with the first receptacle;
a second channel extending through the at least one side to intersect with the first channel, the second channel being concentric with the second receptacle; and
a first recess in the at least one side;
a hand file with a tang disposed in the first receptacle, the tang engaged by the nut; and
a fastener disposed in the body receptacle, the fastener engaging the nut and the tang.

16. The hand file secured in the handle of claim 15 wherein:
the second channel has a second channel thread and the second channel thread is #10-40 UNC, and
the first channel has a first channel thread and the first channel thread is ¼-28 UNF.

17. The hand file secured in the handle of claim 16 wherein:
the thread of the first channel bites into the tang when the tang is screwingly inserted into the first channel.

18. The hand file secured in the handle of claim 15 wherein the nut is made of heat-treated high carbon steel.

19. The hand file secured in the handle of claim 15 wherein:
the nut body has six sides with each adjacent side forming six corners and wherein each of the six corners has a recess.
